(19) United States
(12) Patent Application Publication
(10) Pub. No.: US 2010/0228704 A1
(43) Pub. Date: Sep. 9, 2010

(54) Recognizing a disc

(75) Inventors: Robert Dennis Kahlbaum, Ypsilanti, MI (US); Lars William Anderson, Ann Arbor, MI (US)

Correspondence Address: PATENT DEPARTMENT;ROVI CORPORATION, 2830 DE LA CRUZ BOULEVARD, SANTA CLARA, CA, 95050, US

(73) Assignee: All Media Guide, LLC

(21) Appl. No.: 12/378,841

(22) Filed: Feb. 20, 2009

(51) Int. Cl. G06F 17/30; G06F 7/00

(52) U.S. Cl. 707/698; 707/E17.001; 707/803

(57) ABSTRACT

A method and a system are provided for recognizing a disc. In one example, the system receives a disc, such as, for example, a Blu-ray Disc. The disc includes a content certificate and data files. The content certificate includes a unique text file that certifies the disc complies with predetermined disc parameters. The data files are the actual audio and/or video content on the disc. The system reads the content certificate or reads the data related to the data files. The system generates a hash value by applying a hash function to the content certificate or to the data related to the data files. The hash value is a unique identifier for the disc.

### FIELD OF THE INVENTION

The present invention relates to recognizing a disc. More particularly, the present invention relates to recognizing an optical disc, such as, for example, a Blu-ray Disc.

### BACKGROUND

Previously, a conventional optical disc, such as a compact disc (CD) or a digital video disc (DVD), does not have certain metadata on the disc. Metadata are data that may be used to describe or identify a digital recording. Accordingly, these discs cannot be recognized by referring to metadata on the disc because there is typically no metadata on the disc.

A conventional compact disc is typically recognized by reading table of contents data from the disc and using the data to lookup information in a database. U.S. Pat. Nos. 6,230,192 and 6,330,593 (the '192 and '593 patents), which are hereby incorporated by reference, provide conventional examples of such a method. The '192 and the '593 patents relate generally to delivering supplemental entertainment content to a user listening to a musical recording. Using conventional techniques, an album identifier is computed for the album being played. The album identifier may be determined based on the number and lengths of tracks on the album. The album identifier is used to retrieve, from a database, information relating to the recordings played by the user.

### SUMMARY

A conventional system may compute the album identifier upon detection of a compact disc in a CD player of the user's computer and send the album identifier to a remote server hosting a Web site containing information about the albums. A conventional server uses the album identifier as a key to lookup at least one matching record in an albums database and outputs the album information stored in that matching record.

Unfortunately, conventional systems do not account for some of the obstacles related to identifying a modern disc. For instance, Blu-ray technology presents a new set of challenges for identifying a disc, and conventional methods for identifying such discs are not readily applicable.

In one embodiment, a method is provided for recognizing a disc by using a content certificate. The method comprises receiving a disc that includes a content certificate having a predetermined location on the disc. The method further comprises reading the content certificate from the disc. The content certificate includes a unique text file. The method further comprises generating a hash value by applying a hash function to the content certificate. The hash value is a unique identifier for the disc.

In a second embodiment, a system is provided for recognizing a disc by using a content certificate. The system is configured for receiving a disc that includes a content certificate having a predetermined location on the disc. The system is further configured for reading the content certificate from the disc. The content certificate includes a unique text file. The system is further configured for generating a hash value by applying a hash function to the content certificate. The hash value is a unique identifier for the disc.

In a third embodiment, a computer readable medium comprises one or more instructions for recognizing a disc by using a content certificate. The one or more instructions, when executed by one or more processors, cause the one or more processors to perform the steps of the following: receiving a disc, wherein the disc includes a content certificate having a predetermined location on the disc; reading the content certificate from the disc, wherein the content certificate includes a unique text file; and generating a hash value by applying a hash function to the content certificate, wherein the hash value is a unique identifier for the disc.

In a fourth embodiment, a method is provided for recognizing a disc by using data files. The method comprises receiving a disc that includes one or more data files. The method further comprises reading data related to the one or more data files. Each of the one or more data files comprises audio data and/or video data. The method further comprises generating a hash value by applying a hash function to data related to the one or more data files. The hash value is a unique identifier for the disc.

In a fifth embodiment, a system is provided for recognizing a disc by using data files. The system is configured for receiving a disc that includes one or more data files. The system is further configured for reading data related to the one or more data files. Each of the one or more data files comprises audio data and/or video data. The method further comprises generating a hash value by applying a hash function to data related to the one or more data files. The hash value is a unique identifier for the disc.

In a sixth embodiment, a computer readable medium comprises one or more instructions for recognizing a disc by using data files. The one or more instructions, when executed by one or more processors, cause the one or more processors to perform the steps of the following: receiving the disc, wherein the disc includes one or more data files; reading data related to the one or more data files, wherein each of the one or more data files includes at least one of audio data and video data; and generating a hash value by applying a hash function to the data related to the one or more data files, wherein the hash value is a unique identifier for the disc.

In some embodiments, the method, and/or system is further configured for retrieving metadata related to the unique identifier from a database storing the metadata, and then displaying the metadata related to the unique identifier.

In some cases, the database is configured to be coupled to a user device. The user device may be configured to retrieve the metadata from the database and to display the metadata. The user device may be, for example, one of the following: a disc player; a Blu-ray disc player; a compact disc player; a digital video disc player; a personal computer; a laptop computer; a personal media device; a portable media player; an iPod® device; and a Zoom Player device.

In some cases, the database is configured to be coupled to a server that is accessible to a user device over a network. The server may be configured to retrieve the metadata from the database. The user device may be configured to display the metadata.

In some embodiments, the unique identifier may allow the disc to be uniquely recognized without interpreting contents of the content certificate or the data files. The unique identifier may be in a standard format and is smaller than the content certificate.

In some embodiments, the method and/or system is further configured for locating the content certificate or the data files by using predetermined disc parameters. The predetermined disc parameters comprise a location of the content certificate or the data files. In a particular implementation, the predetermined disc parameters may comprise Blu-ray Disc parameters.

In some embodiments, the unique text file of the content certificate is a certification that the disc complies with predetermined disc parameters.

In some of the embodiments described herein, the disc is readable by using a laser beam having a wavelength of preferably less than about 650 nm. Such a disc may be, for example, a Blu-ray Disc. A Blu-ray Disc is configured to be readable by a laser beam having a wavelength of 405 nm. Some implementations of the invention are particularly useful for the storage and retrieval of high definition audio and/or video content. Such content may be contained on, for example, a Blu-ray Disc.

The invention encompasses other embodiments configured as set forth above and with other features and alternatives. It should be appreciated that these embodiments may be implemented in numerous ways, including as a method, a process, an apparatus, a system or a device.

### BRIEF DESCRIPTION OF THE DRAWINGS

The inventive embodiments will be readily understood by the following detailed description in conjunction with the accompanying drawings. To facilitate this description, like reference numerals designate like structural elements.

FIG. 1 is a block diagram of a system for recognizing a disc, in accordance with some embodiments;

FIG. 2 is a block diagram of a system that is networked and configured for recognizing a disc, in accordance with some embodiments;

FIG. 3 is a schematic diagram of a system for generating a unique identifier from a content certificate file from a disc, in accordance with some embodiments;

FIG. 4 is a schematic diagram of a system for generating a unique identifier from one or more data files from a disc, in accordance with some embodiments;

FIG. 5 is a schematic diagram of a system for generating a unique identifier from subsets of data files from a disc, in accordance with some embodiments;

FIG. 6 is a schematic diagram of a system for generating a unique identifier from the sizes of data files from a disc, in accordance with some embodiments;

FIG. 7 is a flowchart of a method for recognizing a disc by using a content certificate from the disc, in accordance with some embodiments; and

FIG. 8 is a flowchart of a method for recognizing a disc by using one or more data files from the disc, in accordance with some embodiments.

### DETAILED DESCRIPTION

An invention is disclosed for a method and a system for recognizing a disc. Numerous specific details are set forth in order to provide a thorough understanding of various embodiments. It will be understood, however, to one skilled in the art, that the embodiments may be practiced with other specific details.

### DEFINITIONS

Some terms are defined below for clarity purposes. These terms are not rigidly restricted to these definitions. These terms and other terms may also be defined by their use in the context of this description. For instance, some embodiments are particularly applicable to Blu-ray.

“Blu-ray”, also known as Blu-ray Disc, means a disc format jointly developed by the Blu-ray Disc Association, and personal computer and media manufacturers (including Apple, Dell, Hitachi, HP, JVC, LG, Mitsubishi, Panasonic, Pioneer, Philips, Samsung, Sharp, Sony, TDK and Thomson). The format was developed to enable recording, rewriting and playback of high-definition video (HD), as well as storing large amounts of data. The format offers more than five times the storage capacity of conventional DVDs and can hold 25 GB on a single-layer disc and 500 GB on a 20-layer disc. More layers and more storage capacity may be feasible as well. This extra capacity combined with the use of advanced audio and/or video codecs offers consumers an unprecedented HD experience. While disc technologies, such as CD and DVD, rely on a red laser to read and write data, the Blu-ray format uses a blue-violet laser instead, hence the name Blu-ray. The benefit of using a blue-violet laser (405 nm) is that it has a shorter wavelength than a red laser (650 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc is the same size as a traditional CD or DVD.

“Chapter” means an audio and/or video data block on a disc, such as a Blu-ray Disc, a CD or a DVD. A chapter stores at least a portion of an audio and/or video recording.

“Compact Disc” (CD) means a disc used to store digital data. A CD was originally developed for storing digital audio. Standard CDs have a diameter of 120 mm and can hold up to 80 minutes of audio. There is also the Mini CD, with diameters ranging from 60 to 80 mm; they are sometimes used for CD singles, storing up to 24 minutes of audio. CD technology has also been adapted and expanded to include data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD.

“Content certificate” means a unique text file that is present on a disc, such as, for example, a Blu-ray Disc. Each content certificate is unique as it is derived from a cryptographic hash of the contents of the disc. The content certificate is a certification that the disc complies with predetermined disc parameters, such as, for example, Blu-ray Disc parameters. Thus, if, for example, the contents of a given Blu-ray Disc change for any reason (alterations to correct errors, new version, etc.), then the Content Certificate is no longer valid and another one must be purchased from Advanced Access Content System Licensing Administrator (AACS LA).

“Data file” means a file that comprises at least a portion of the actual audio and/or video content on a disc. A disc typically comprises a plurality of data files. The plurality of data files collectively comprises the audio and/or video content on the disc. A data file preferably has a file format that is supported by predetermined disc parameters, such as, for example, Blu-ray Disc parameters. Blu-ray Discs are capable of supporting various file formats, including without limitation M2TS, MPEG-2, MPEG-4 AVC, and SMPTE VC-1. “M2TS” is a common Blu-ray file format and is defined below. Blu-ray data files may enable a Blu-ray Disc to store up to four hours worth of high definition television (HDTV) audio and/or video per layer. Blu-ray Discs are also capable of supporting the different multi-channel audio file formats, such as the different file formats of Dolby® and Digital Theater Systems® (DTS®), as well as pulse-code modulation (PCM) audio file formats. Blu-ray Disc rewritable and recordable disc formats are backwards-compatible with older formats such as MPEG-2, while newer codecs enable Blu-ray technology to support new and/or planned file formats. The integration of Java cross platforms enable the Blu-ray Disc to have interactive menus as well as the capability to add new content or updates such as new subtitles through the Internet.

“Device” means hardware, software or a combination thereof. A device may sometimes be referred to as an apparatus. Each device is configured to carry out one or more steps of the method of recognizing a Blu-ray Disc.

“Hashing” means applying a hash function to specified data. A hash function is a procedure or mathematical function which converts a large, possibly variable-sized amount of data into a smaller amount of data, usually a single integer that may serve as an index into an array. The values returned by a hash function are called hash values, hash codes, hash sums, or simply hashes. Hash functions are mostly used to speed up table lookup or data comparison tasks, such as finding items in a database, detecting duplicated or similar records in a large file, and so on.

“Metadata” generally means data that describes data. More particularly, metadata means data that describes the contents of a digital audio/video recording. For example, metadata may include without limitation movie title, actors names, director name, and/or genre of movie (e.g., horror, drama or comedy).

“M2TS” (e.g., “.m2ts”) means MPEG-2 transport stream. An M2TS file is an audio and/or video file saved in the Blu-ray Disc Audio/Visual (BDAV) format. An M2TS file may be used for saving audio and/or video data on Blu-ray Discs. An M2TS file supports 720p and 1080i formats. Each M2TS transport stream is its own file and file names are typically of the form XXXXX.m2ts (where “XXXXX” is a five-digit number followed by .m2ts).

“Network” means a connection between any two or more computers, which permits the transmission of data. A network may be any combination of networks, including without limitation the Internet, a local area network, a wide area network, a wireless network and a cellular network.

“Pressing” (e.g., “disc pressing”) means producing a disc in a disc press from a master. The disc press preferably includes a laser beam having a bandwidth of less than about 650 nm, such as, for example, 405 nm.

“Table of Contents” (TOC) means the list of tracks (or chapters), the track (chapter) start times and the track (or chapter) end times on a disc, such as a Blu-ray Disc, a CD or a DVD. The TOC data consists of a string of concatenated track (or chapter) start times for every track (or chapter) on a disc. The track start times on a disc are typically expressed as six-digit hexadecimal values. U.S. Pat. No. 7,359,900 (the '900 patent), entitled “Digital Audio Track Set recognition System”, which is hereby incorporated by reference, provides an example of a method of using TOC data to identify a CD or DVD. The '900 patent also describes a method of using the identification of a disc to lookup metadata in a database and then sending that metadata to an end user.

“Track” means an audio data block on a disc, such as a Blu-ray Disc, a CD or a DVD. A track stores at least a portion of an audio recording.

“User device” (e.g., “user computer”, “client”, or “client device”) may refer to a single computer or to a network of interacting computers. A computer is a combination of a hardware system, a software operating system and perhaps one or more software application programs. Examples of a user device include without limitation a Blu-ray Disc player, a personal media device, a portable media player, an iPod®, a Zoom Player, a laptop computer, a palmtop computer, a smart phone, a cell phone, a mobile phone, an mp3 player, a digital audio recorder, a digital video recorder, a CD player, a DVD player, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox® and Microsoft Internet Explorer®.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo® Web server.

“Web site” means at least one Web page, and more commonly a plurality of Web pages, virtually connected to form a coherent group.

For the implementations of the present system, a software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

### Architecture Overview

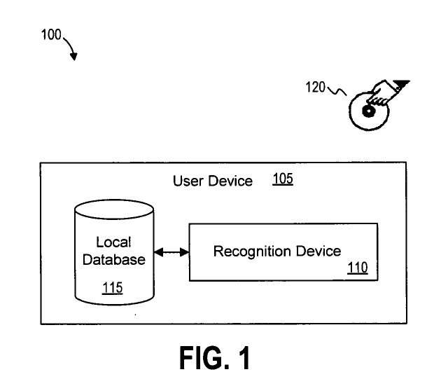

FIG. 1 is a block diagram of a system 100 for recognizing a disc, in accordance with some embodiments. The computer includes without limitation a recognition device 110 and a local database 115. The recognition device 110 performs the more important operations of recognizing a disc 120. The user device 105 may be, for example, a standalone disc player or a laptop computer, among other things. The recognition device 110 is coupled to the local database 115. The local database 115 may store, among other things, data collected and/or generated from a disc 120 that is inputted into the user device 105. In other embodiments, the local database 115 may be located externally to the user device 105. Other configurations between the local database 115 and the recognition device 110 exist as well.

The recognition device 110 may be configured for recognizing a disc 120 by generating a unique identifier based on data stored on the disc. The recognition device 110 utilizes the fact that a disc 120 has files that are organized according to predetermined disc parameters, such as, for example, Blu-ray Disc parameters. The disc parameters preferably include the location of the content certificate, the locations of the data files, the sizes of the data files, and/or the durations of the data files. A disc may include various standard file types, including without limitation audio and/or video data files (e.g., M2TS files) and a mandatory content certificate. Various configurations of systems that include a recognition device 110 are described with reference to the appropriate figures.

### Recognizing a Disc by Using the Content Certificate

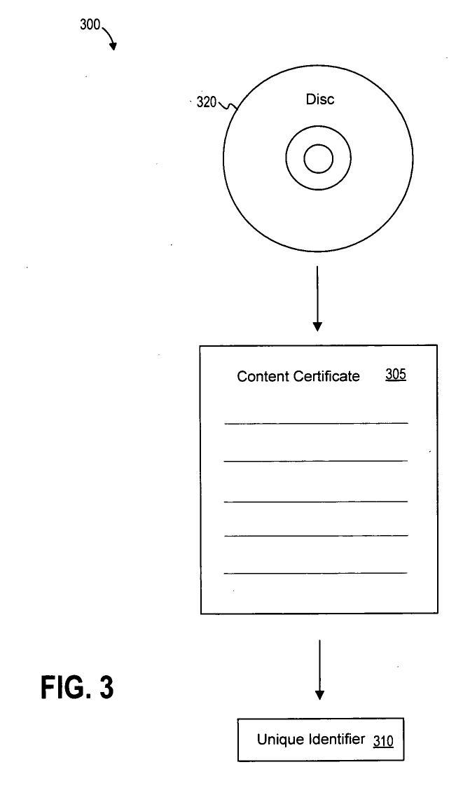

FIG. 3 is a schematic diagram of a system 300 for generating a unique identifier 310 from a content certificate file 305 from a disc 320, in accordance with some embodiments. The disc 320 may be, for example, a Blu-ray Disc. Each disc contains a content certificate 305. Each content certificate 305 is unique because it was previously derived from a cryptographic hash of the contents of the disc 320. The content certificate 305 is a text file that is unique for each different pressing of a given disc. A pressing of a disc comprises producing a disc in a disc press from a master. The disc press preferably includes a laser comprising a beam having a wavelength of less than about 650 nm, such as, for example, 405 nm.

The system 300 is configured for hashing the content certificate 305. The hashing includes reading the content certificate 305 and generating a hash value from the content certificate 305. In some embodiments, searching for the content certificate 305 is unnecessary. The content certificate 305 may be in a predetermined location according to predetermined disc parameters, such as, for example, Blu-ray parameters. Accordingly, the system 300 may advantageously locate and read the content certificate 305 without searching for the content certificate 305. Not having to search for the content certificate 305 allows the system 300 to save time. The time savings may be a few seconds in some instances.

The hash value is the unique identifier 310, standardized in format and smaller than the content certificate 305. The unique identifier 310 allows the disc 320 to be uniquely recognized without interpreting the contents of the content certificate 305. Interpreting means decoding the content certificate 305 for the purpose of making sense of the content certificate 305. The content certificate that the system 300 reads may be encoded and may not make sense from an understanding perspective. However, the content certificate 305 does not need to make sense when the system 300 reads the content certificate 305 for hashing purposes, and not for understanding purposes.

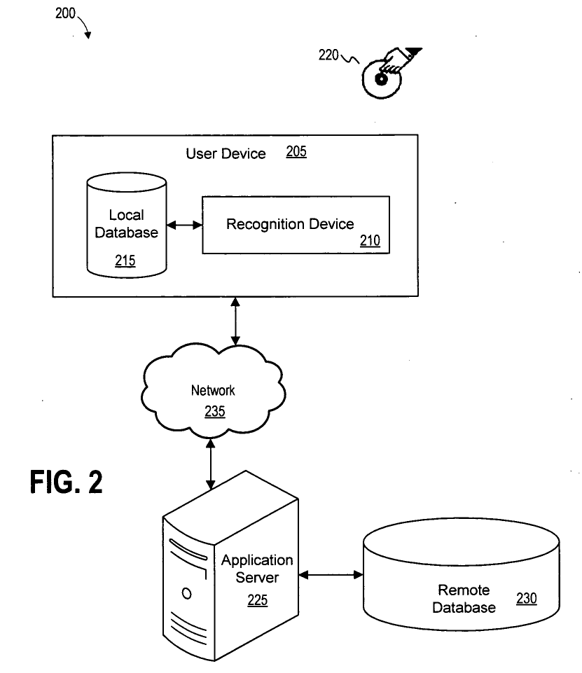

Given the unique identifier (e.g., hash value), the system 300 may then lookup the metadata related to the unique identifier 310. Metadata is data that describes the contents of a digital audio/video recording. For example, metadata may include without limitation movie title, actors names, director name, and/or genre of movie (e.g., horror, drama or comedy). This metadata lookup process is described in more detail below with reference to FIG. 2.

Table 1 below is an example of a unique identifier in the form of a hash value according to some embodiments. This particular unique identifier is a result of the system 300 performing a hash on a content certificate of a movie encoded on a Blu-ray Disc.

TABLE 1
Example of a Unique Identifier
2b4c4a19cfeefa35f5d3a54a4d12a5ec

Table 1 is the base of the hash. The base is the important component of the hash. In some embodiments, the system 300 may append a prefix and/or suffix to the hash to signify directly the type of table of contents. For example, in a particular implementation, the letter “R” may be a prefix and/or suffix that the system 300 appends to the hash to signify directly that the table of contents is a Blu-ray Disc table of contents.

### Overview of Method for Recognizing a Disc by Using the Content Certificate

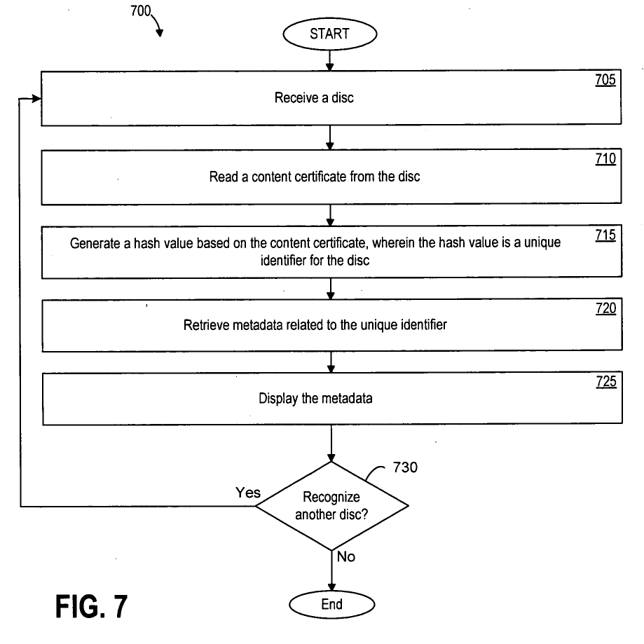

FIG. 7 is a flowchart of a method 700 for recognizing a disc by using the content certificate from the disc, in accordance with some embodiments. In some implementations, the steps of the method 300 may be carried out by the user device 105 of FIG. 1.

The method 700 starts in a step 705 where the system receives a disc. The disc is preferably readable by using a laser comprising a beam having a wavelength of less than about 650 nm. Such a disc may be, for example, a Blu-ray Disc. The method 700 then moves to a step 710 where the system reads a content certificate from the disc. The system preferably reads the disc by using a laser beam having a wavelength of less than about 650 nm. Such a system may include, for example, a Blu-ray Disc player configured to read a Blu-ray Disc. Next, in a step 715, the system generates a hash value based on the content certificate. The hash value is a unique identifier for the disc.

The unique identifier is useful for a variety purposes. For instance, the unique identifier may be used for the following purposes without limitation: retrieving metadata related to a particular disc, playing back a particular disc, distinguishing a particular disc from another disc, and matching a particular disc to another disc that is substantially the same. For example, in FIG. 7, the method 700 moves to a step 720 where the system retrieves metadata related to the unique identifier. This retrieval of metadata may involve accessing, for example, a local database and/or a remote database. The method 700 then proceeds to a step 725 where the system displays the metadata.

Next, in a decision operation 730, the system determines if another disc is to be recognized. For example, a user may insert another disc into a player for the disc to be recognized. If another disc is to be recognized, then the method 700 returns to the step 705 where the system receives the disc. However, if another disc is not to be recognized, then the method 700 concludes after the decision operation 730.

Note that these methods may include other details and steps that are not discussed in this method overview. Other details and steps are discussed above with reference to the appropriate figures and may be a part of the methods, depending on the embodiment.

### Recognizing a Disc by Using the Contents of Data Files

The architecture for recognizing a disc by using the contents of data files is described above with reference to FIG. 1. A data file is a file that comprises at least a portion of the actual audio and/or video content on a disc. A disc typically comprises a plurality of data files. The plurality of data files collectively comprises the audio and/or video content on the disc.

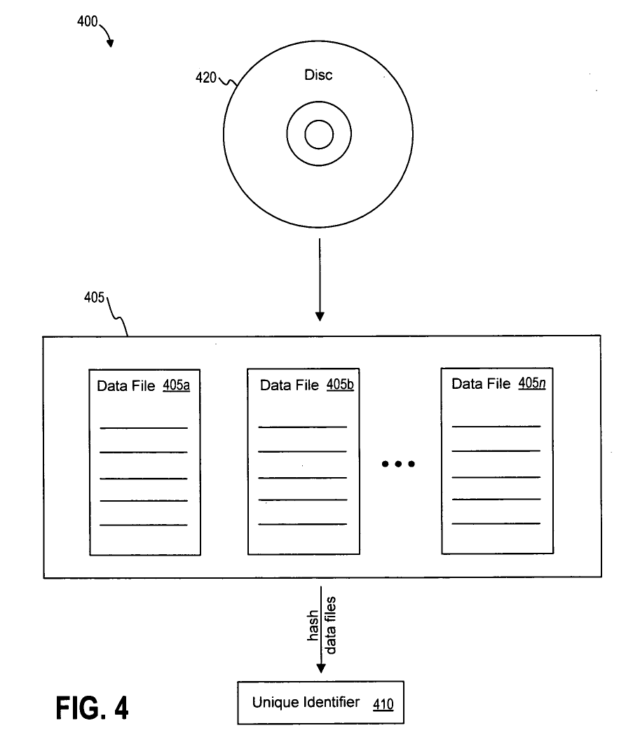

FIG. 4 is a schematic diagram of a system 400 for generating a unique identifier 410 from the contents of one or more data files 405 from a disc 420, in accordance with some embodiments. The disc 420 may be, for example, a Blu-ray Disc. Each of the data files 405 preferably has a file format that is supported by a Blu-ray Disc. Blu-ray Discs are capable of supporting various file formats, including without limitation M2TS, MPEG-2, MPEG-4 AVC, and SMPTE VC-1.

The disc 420 may contain one or more data files 405. For explanatory purposes, the disc 420 of FIG. 4 has multiple data files, including Data File 405a, Data File 405b . . . . Data File 405n, where n is a positive integer. The data files 405 contain the actual audio and/or video data for the disc 420, which may be a Blu-ray Disc in some embodiments.

The system 400 is configured for hashing the contents of one or more data files 405 for the disc. The hashing includes reading the contents of the data files 405 and generating a hash value from the data files 405. The system 400 preferably reads, without interpreting, the contents of the data files 405. Interpreting means decoding audio and/or video data for the purpose of playing the audio and/or video data on a multimedia device. The data files 405 that the system 400 reads may be encoded data and may not make sense for playback purposes if the data is not decoded. However, the data files 405 do not need to make sense when the system 400 reads the data files 405 for hashing purposes, and not for playback purposes. The hash value is the unique identifier 410 and corresponds specifically to the precise audio and/or video data of the data files 405. The unique identifier 410 is independent of a specific pressing of the disc.

Given the unique identifier (e.g., hash value), the system 400 may then lookup the metadata related to the unique identifier 410. The metadata is data that describes the contents of a digital audio/video recording. For example, metadata may include without limitation movie title, actors names, director name, and/or genre of movie (e.g., horror, drama or comedy). This metadata lookup process is described in more detail below with reference to FIG. 2.

### Recognizing a Disc by Using Subsets of the Contents of Data Files

The architecture for recognizing a disc by using subsets of the contents of data files is described above with reference to FIG. 1. A data file is a file that comprises at least a portion of the actual audio and/or video content on a disc. A disc typically comprises a plurality of data files. The plurality of data files collectively comprises the audio and/or video content on the disc. A subset of a data file, described further below, is a portion of a data file.

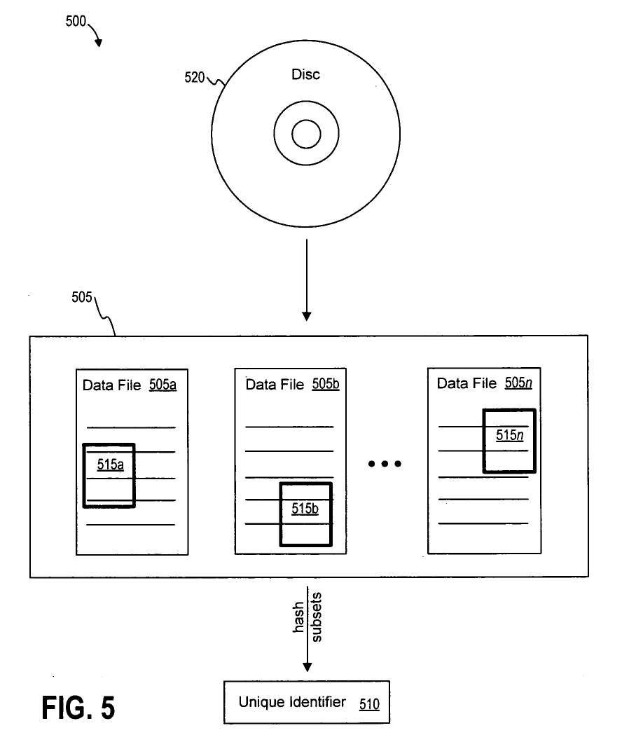

FIG. 5 is a schematic diagram of a system 500 for generating a unique identifier 510 from subsets of data files 505 from a disc 520, in accordance with some embodiments. The disc 520 may be, for example, a Blu-ray Disc. Each of the data files 505 preferably has a file format that is supported by a Blu-ray Disc. Blu-ray Discs are capable of supporting various file formats, including without limitation M2TS, MPEG-2, MPEG-4 AVC, and SMPTE VC-1.

The disc 520 may contain one or more data files 505. For explanatory purposes, the disc 520 of FIG. 5 has multiple data files, including Data File 505a, Data File 505b . . . . Data File 505n, where n is a positive integer. The data files 505 contain the actual audio and/or video data for the disc 520, which may be a Blu-ray Disc in some embodiments.

The system 500 is configured for reading one or more subsets from each of the data files 505. For explanatory purposes, FIG. 5 shows one subset for each of the data files 505. For example, Data File 505a shows one Subset 515a. Data File 505b shows one Subset 515b. Data File 505n shows one Subset 515n, where n is a positive integer. Again, however, multiple subsets may be read from each of the data files 505.

A subset may have any size less than the size of the corresponding data file. A subset may have any duration less than the duration of the corresponding data file. A subset may have any location within the corresponding data file.

For example, the system 500 may be configured for reading one subset that is 10 seconds long, reading another subset that is 15 MB in size, and reading yet another subset that is 7 minutes long. The system 500 may be configured for reading a subset 505 at one or more points within each data file. For example, the system 500 may read a subset at the 1:00 minute mark of a Data File 505a, and/or the system 500 may read a subset at the 5:32 mark of the same Data File 505a. For explanatory purposes, FIG. 5 shows the system 500 reading just one subset at only one point for each data file.

Using subsets 505, the system 500 may perform hashing that includes reading substantially less data than a full data file. Nevertheless, the system 500 may generate a hash value that is likely to be sufficiently unique without interpreting the contents of the data files 505. As discussed above with reference to FIG. 4, interpreting means decoding audio and/or video data for the purpose of playing the audio and/or video data on a multimedia device. The data files 505 that the system 500 reads may be encoded data and may not make sense for playback purposes if the data is not decoded. However, the data files 505 do not need to make sense when the system 500 reads the data files for hashing purposes, and not for playback purposes. The hash value is the unique identifier 510.

Given the unique identifier (e.g., hash value), the system 500 may then lookup the metadata related to the unique identifier 510. The metadata is data that describes the contents of a digital audio/video recording. For example, metadata may include without limitation movie title, actors names, director name, and/or genre of movie (e.g., horror, drama or comedy). This metadata lookup process is described in more detail below with reference to FIG. 2.

### Recognizing a Disc by Using Sizes of Data Files

The architecture for recognizing a disc by using the sizes of data files is described above with reference to FIG. 1. A data file is a file that comprises at least a portion of the actual audio and/or video content on a disc. A disc typically comprises a plurality of data files. The plurality of data files collectively comprises the audio and/or video content on the disc. The size of a data file is the amount of contents in a data file. The size of a data file is typically measured in bytes.

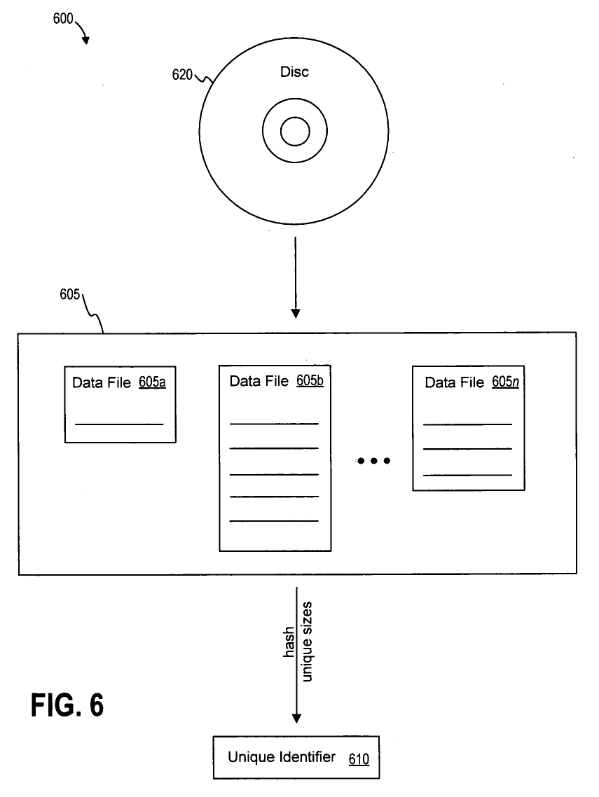

FIG. 6 is a schematic diagram of a system 600 for generating a unique identifier 610 from the sizes of data files 605 from a disc 620, in accordance with some embodiments. The disc 620 may be, for example, a Blu-ray Disc. Each of the data files 605 preferably has a file format that is supported by a Blu-ray Disc. Blu-ray Discs are capable of supporting various file formats, including without limitation M2TS, MPEG-2, MPEG-4 AVC, and SMPTE VC-1.

The disc 620 may contain one or more data files 605. For explanatory purposes, this example of the system 600 shows the disc 620 having multiple data files, including Data File 605a, Data File 605b . . . . Data File 605n, where n is a positive integer. The data files 605 contain the actual audio and/or video data for the disc 620, which may be a Blu-ray Disc in some embodiments.

The system 600 is preferably configured to hash the size(s) of the one of more data files 605 that are each likely to have a sufficiently unique size. A unique size is a size that will allow the system 600 to generate a hash value that is unique. The hashing includes reading the sizes, identifying the unique sizes, and generating a hash value from the unique sizes. The hash value is the unique identifier 610.

The system 600 may generate the unique identifier 610 without interpreting the contents of each of the data files 605. As discussed above with reference to FIG. 4, interpreting means decoding audio and/or video data for the purpose of playing the audio and/or video data on a multimedia device. The data files 605 that the system 600 reads may be encoded data and may not make sense for playback purposes if the data is not decoded. However, the data files 605 do not need to make sense when the system 600 reads the data files for hashing purposes, and not for playback purposes.

The system 600 may use any appropriate statistical analysis technique to identify the sizes that are sufficiently likely to be unique compared to other sizes on the disc. For example, the system 600 may hash sizes that are more than one standard deviation away from the mean size. Other techniques for identifying unique sizes exist as well.

Table 2 below shows an example list of sizes for various data files on a disc. One technique for identifying the unique sizes is discussed below with reference to Table 2.

TABLE 2
Sizes of Data Files on a Disc

| DATA FILE | SIZE (MB) |
|---|---|
| Data File 1 | 1 |
| Data File 2 | 850 |
| Data File 3 | 300 |
| Data File 4 | 305 |
| Data File 5 | 312 |
| Data File 6 | 303 |
| Data File 7 | 295 |
| Data File 8 | 305 |
| Data File 9 | 307 |
| Data File 10 | 305 |
| Data File 11 | 306 |

Some sizes in Table 2 are likely to be sufficiently unique. In some embodiments, the system 600 is likely to identify the sizes of Data Files 1 and 2 as being sufficiently unique. As is readily apparently, the sizes of Data Files 1 and 2 are substantially different than the sizes of Data Files 3-11. The sizes of Data Files 1 and 2 happen to be more than one standard deviation away from the average size of 326. Accordingly, in some embodiments, the system 600 may use the sizes of Data Files 1 and 2 for hashing because these sizes are likely to be sufficiently unique.

Some files in Table 2 are likely to be insufficiently unique. In some embodiments, the system 600 is likely to identify Data Files 3-11 as being insufficiently unique. As is readily apparently, the sizes of Data Files 3-11 are substantially similar and non-unique. The sizes of Data Files 3-11 happen to be less than one standard deviation away from the average size of 326. Accordingly, in some embodiments, the system 600 may not use the sizes of Data Files 3-11 for hashing because these sizes are likely to be insufficiently unique.

The system 600 preferably does not use any sizes that are likely to be insufficiently unique. The system 600 may be configured to identify any sizes that are likely to be insufficiently unique. The remaining sizes are, by default, likely to be sufficiently unique. In such a case, after identifying the insufficiently unique sizes, the system 600 may then use the remaining sizes for hashing.

For explanatory purposes, FIG. 6 shows data files 605 of uniquely different sizes. The data files may have sizes that are in a range that spans, for example, from 1 kilobyte to 9 megabytes. The system 600 hashes the sizes to obtain a hash value, which is the unique identifier.

Given the unique identifier (e.g., hash value), the system 600 may then lookup the metadata related to the unique identifier 610. The metadata is data that describes the contents of a digital audio/video recording. For example, metadata may include without limitation movie title, actors names, director name, and/or genre of movie (e.g., horror, drama or comedy). This metadata lookup process is described in more detail below with reference to FIG. 2.

### Overview of Method for Recognizing a Disc by Using Data Files

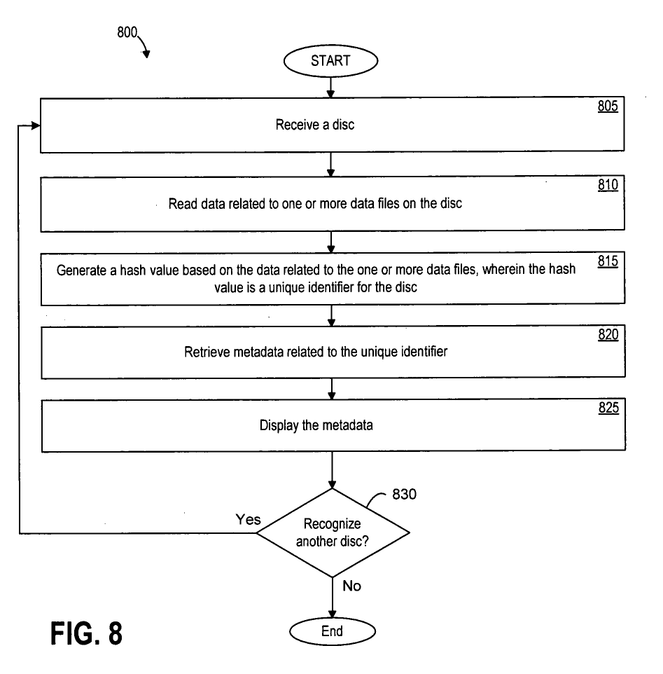

FIG. 8 is a flowchart of a method 800 for recognizing a disc by using one or more data files, in accordance with some embodiments. In some implementations, the steps of the method 800 may be carried out by the user device 105 of FIG. 1.

The method 800 starts in a step 805 where the system receives a disc. The disc is preferably readable by using a laser comprising a beam having a wavelength of less than about 650 nm. Such a disc may be, for example, a Blu-ray Disc. The method 800 then moves to a step 810 where the system reads data related to one or more data files on the disc. The system preferably reads the disc by using a laser comprising a beam having a wavelength of less than about 650 nm. Such a system may include, for example, a Blu-ray Disc player configured to read a Blu-ray Disc. Next, in a step 815, the system generates a hash value based on the data related to the one or more data files. The hash value is a unique identifier for the disc.

The unique identifier is useful for a variety purposes. For instance, the unique identifier may be used for the following purposes without limitation: retrieving metadata related to a particular disc, playing back a particular disc, distinguishing a particular disc from another disc, and matching a particular disc to another disc that is substantially the same. For example, in FIG. 8, the method 800 moves to a step 820 where the system retrieves metadata related to the unique identifier. This retrieval of metadata may involve accessing, for example, a local database and/or a remote database. The method 800 then proceeds to a step 825 where the system displays the metadata.

Next, in a decision operation 830, the system determines if another disc is to be recognized. For example, a user may insert another disc into a player for the disc to be recognized. If another disc is to be recognized, then the method 800 returns to the step 805 where the system receives the disc. However, if another disc is not to be recognized, then the method 800 concludes after the decision operation 830.

Note that these methods may include other details and steps that are not discussed in this method overview. Other details and steps are discussed above with reference to the appropriate figures and may be a part of the methods, depending on the embodiment.

### Using Unique Identifier to Lookup Metadata

FIG. 2 is a block diagram of a system 200 that is networked and configured for recognizing a disc 220, in accordance with some embodiments. The computer includes without limitation a recognition device 210 and a local database 215. The recognition device 210 performs the more important operations of recognizing a disc 220. The user device 205 may be, for example, a standalone disc player or a laptop computer, among other things. The recognition device 210 is coupled to the local database 215. The local database 215 may store, among other things, data collected and/or generated from a disc 220 that is inputted into the user device 205. In other embodiments, the local database 215 may be located externally to the user device 205. Other configurations between the local database 215 and the recognition device 210 exist as well.

The recognition device 210 may be configured for recognizing a disc 220 by generating a unique identifier based on data stored on the disc. The recognition device 210 utilizes the fact that a disc 220 has files that are organized according to predetermined disc parameters, such as, for example, Blu-ray Disc parameters. The disc parameters preferably include the location of the content certificate, the locations of the data files, the sizes of the data files, and/or the durations of the data files. A disc may include various standard file types, including without limitation audio and/or video data files (e.g., M2TS files) and a mandatory content certificate. Various configurations of systems that include a recognition device 210 are described with reference to the appropriate figures.

A network 235 is coupled to an application server 225 and the user device 205. The network 235 may also be coupled to other user devices (not shown). The application server 225 is coupled to (or includes) a remote database 230. The remote database 230 may store, among other things, data collected and/or generated from a disc 220 that is inputted into the user device 205.

The user device 205 includes hardware and/or software configured for communicating with the application server 215 to retrieve and send information corresponding to a unique identifier of a disc. For example, the user device 205 may have an operating system with a graphical user interface (GUI) to access the Internet and is preferably equipped with World Wide Web (Web) browser software, such as Mozilla Firefox®, operable to read and send Hypertext Markup Language (HTML) forms from and to a Hypertext Transport Protocol (HTTP) server on the Web. A standalone disc player may have a built-in interface that enables the player to communicate with the application server 225 via the network 235, either directly or through another computer. For example, a disc player may have a data interface (e.g., an IDE interface or a USB interface) that enables the disc player to send and receive data from a laptop computer, which in turn is coupled to the network 235.

Likewise, the application server 225 includes hardware and software for communicating with the user device 205. For example, the application server 225 may have HTTP compliant software, an operating system and common gateway interface (CGI) software for interfacing with the user device 205 via the network 235. Alternatively, the application server 225 and user device 205 may run proprietary software that enables them to communicate via the network 235.

It will be readily appreciated that the schematic of FIG. 2 is for explanatory purposes, and that numerous variations are possible. For example, the application server 225 may be connected to a local area network (LAN), which in turn may be connected to the network 235. In another example, the application server 225 may be coupled to multiple Web servers. In yet another example, the system 200 may include a database (or system of databases) arranged in a different configuration than the databases depicted here.

Some or all software and data necessary for recognizing a disc may be stored on a local storage device associated with the user device 205. For example, the local database 215 may contain a complete set or a subset of the information available in the corresponding remote database 230 coupled to the application server 225. The user device 205 may load the local database 215 with metadata and unique identifiers from a CD-ROM (not shown). The local database 215 may be on the hard disk of the user device 205. Alternatively, the user device 205 may download data to the local database 215 from the remote database 230 via the network 235. Other configurations exist as well.

Accordingly, the user device 205 may access the remote database 230 via the network 235 or may download at least a portion of the data from the remote database 230 to the local database 215. The user device 205 may then provide metadata according to a recognized unique identifier in the local database 215 or the remote database 230.

For example, the user may insert a disc while the user device 205 is offline. The disc may be, for example, a Blu-ray Disc. The user device 205 may then provide the relevant metadata automatically by accessing the local database 215 according to the unique identifier. The user device 205 may also retrieve the relevant metadata from the local database 215 upon the user's request. Examples of metadata include without limitation song title, artist name and album title.

In another example, the user may insert a disc while the user device 205 is coupled to the network 235. The disc may be, for example, a Blu-ray Disc. The application server 225 may then provide the relevant metadata automatically by accessing the remote database 230 according to the unique identifier. The user device 205 may also retrieve the relevant metadata from the remote database 230 upon the user's request.

### Computer Readable Medium Implementation

Portions of some embodiments may be conveniently implemented by using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure. The system may also be implemented by the preparation of application-specific integrated circuits or by interconnecting an appropriate network of conventional component circuits.

An implementation may include a computer program product which is a storage medium (media) having instructions stored thereon/in which can be used to control, or cause, a computer to perform any of the processes of the implementation. The storage medium can include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), some implementations include software for controlling both the hardware of the general purpose/specialized computer or microprocessor, and for enabling the computer or microprocessor to interact with a human user or other mechanism utilizing the results of the particular embodiment. Such software may include without limitation device drivers, operating systems, and user applications. Ultimately, such computer readable media further includes software for performing aspects of the method, as described above.

Included in the programming (software) of the general/specialized computer or microprocessor are software modules for implementing the processes described above. The processes described above include without limitation the following: receiving a disc, reading a content certificate or data files from the disc, and generating a hash value by applying a hash function to the content certificate or to the data files.

### ADVANTAGES

Embodiments of the system allow recognition of a disc configured by a disc writer comprising a laser and/or beam having a wavelength of less than about 650 nm. For instance, a Blu-ray Disc comprises a content certificate and one or more data files having a predetermined configuration. The system generates a hash value from a content certificate or from one or more data files. The system is configured to recognize the disc without interpreting contents of the content certificate or the contents of the data files.

The system does not rely on metadata for recognition purposes. Not relying on metadata is a valuable feature because some discs, such as a Blu-ray Disc, do not typically store metadata on the disc. Accordingly, the system may be configured to recognize, for example, an actual Blu-ray Disc that is physically inserted into the system. Recognizing a disc involves, among other things, generating a unique identifier, such as, for example, a hash value. The system may retrieve metadata associated with the unique identifier from a database. The system may then display the metadata on a user device.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for recognizing a disc by using a content certificate, the method comprising:
receiving the disc, wherein the disc includes the content certificate, and wherein the content certificate has a predetermined location on the disc;
reading the content certificate from the disc, wherein the content certificate includes a unique text file; and
generating a hash value by applying a hash function to the content certificate, wherein the hash value is a unique identifier for the disc.

2. The method of claim 1, further comprising at least one of:
retrieving metadata related to the unique identifier from a database storing the metadata; and
displaying the metadata related to the unique identifier.

3. The method of claim 1, wherein the unique identifier is in a standard format and is smaller than the content certificate.

4. The method of claim 1, wherein the unique identifier allows the disc to be uniquely recognized without interpreting contents of the content certificate.

5. The method of claim 1, wherein the disc is at least one of:
a disc that is readable by using a laser comprising a beam having a wavelength of less than about 650 nm;
a disc that is readable by using a laser beam having a wavelength of approximately 405 nm; and
a disc that comprises a Blu-ray Disc format.

6. The method of claim 1, further comprising locating the content certificate by using predetermined disc parameters, wherein the predetermined disc parameters comprise a location of the content certificate.

7. The method of claim 6, wherein the predetermined disc parameters comprise Blu-ray Disc parameters.

8. The method of claim 1, wherein the unique text file of the content certificate is a certification that the disc complies with predetermined disc parameters.

9. The method of claim 2, wherein the database is configured to be coupled to a user device, and wherein the user device is configured to retrieve the metadata from the database and to display the metadata, and wherein the user device is at least one of:
a disc player;
a Blu-ray disc player;
a compact disc player;
a digital video disc player;
a personal computer;
a laptop computer;
a personal media device;
a portable media player;
an iPod® device; and
a Zoom Player device.

10. The method of claim 2, wherein the database is configured to be coupled to a server that is accessible to a user device over a network, wherein the server is configured to retrieve the metadata from the database, and wherein the user device is configured to display the metadata.

11. A system for recognizing a disc by using a content certificate, wherein the system is further configured for at least one of:
receiving the disc, wherein the disc includes the content certificate, and wherein the content certificate has a predetermined location on the disc;
reading the content certificate from the disc, wherein the content certificate includes a unique text file; and
generating a hash value by applying a hash function to the content certificate, wherein the hash value is a unique identifier for the disc.

12. The system of claim 11, wherein the system is further configured for at least one of:
retrieving metadata related to the unique identifier from a database storing the metadata; and
displaying the metadata related to the unique identifier.

13. The system of claim 11, wherein the unique identifier is in a standard format and is smaller than the content certificate.

14. The system of claim 11, wherein the unique identifier allows the disc to be uniquely recognized without interpreting contents of the content certificate.

15. The system of claim 11, wherein the disc is at least one of:
a disc that is readable by using a laser comprising a beam having a wavelength of less than about 650 nm;
a disc that is readable by using a laser beam having a wavelength of approximately 405 nm; and
a disc that comprises a Blu-ray Disc format.

16. The system of claim 11, wherein the system is further configured for locating the content certificate by using predetermined disc parameters, wherein the predetermined disc parameters comprise a location of the content certificate.

17. The system of claim 16, wherein the predetermined disc parameters comprise Blu-ray Disc parameters.

18. The system of claim 11, wherein the unique text file of the content certificate is a certification that the disc complies with predetermined disc parameters.

19. The system of claim 12, wherein the database is configured to be coupled to a user device, and wherein the user device is configured to retrieve the metadata from the database and to display the metadata, and wherein the user device is at least one of:
a disc player;
a Blu-ray disc player;
a compact disc player;
a digital video disc player;
a personal computer;
a laptop computer;
a personal media device;
a portable media player;
an iPod® device; and
a Zoom Player device.

20. The system of claim 12, wherein the database is configured to be coupled to a server that is accessible to a user device over a network, wherein the server is configured to retrieve the metadata from the database, and wherein the user device is configured to display the metadata.

21. A computer readable medium comprising one or more instructions for recognizing a disc by using a content certificate, wherein the one or more instructions, when executed by one or more processors, cause the one or more processors to perform the steps of:
receiving the disc, wherein the disc includes the content certificate, and wherein the content certificate has a predetermined location on the disc;
reading the content certificate from the disc, wherein the content certificate includes a unique text file; and
generating a hash value by applying a hash function to the content certificate, wherein the hash value is a unique identifier for the disc.
